(19) United States
(12) Patent Application Publication
(10) Pub. No.: US 2014/0043718 A1
(43) Pub. Date: Feb. 13, 2014

(54) METHOD FOR ETCHING A BST LAYER

(71) Applicants: STMicroelectronics (Tours) SAS, Tours (FR); STMicroelectronics S.r.l., Agrate Brianza (IT)

(72) Inventors: Vincent Caro, Saint Avertin (FR); Davide Rodilosso, Catania (IT)

(21) Appl. No.: 14/056,698

(22) Filed: Oct. 17, 2013

Related U.S. Application Data
(63) Continuation-in-part of application No. PCT/EP2012/056901, filed on Apr. 16, 2012.

(30) Foreign Application Priority Data
Apr. 20, 2011 (EP) 11305473.8

(51) Int. Cl. H01G 7/06

(52) U.S. Cl. CPC H01G 7/06
USPC 361/281; 252/79.1; 252/79.2; 216/6

(57) ABSTRACT

The disclosure concerns a method for etching a PVD deposited barium strontium titanate layer, wherein a non-ionic surfactant at a concentration between 0.1 and 1 percent is added to an acid etching solution.

### BACKGROUND

1. Technical Field

The present disclosure relates to a method of etching a ferroelectric material. It more specifically relates to a method for etching a barium strontium titanate layer (BST), used in the fabrication of tunable capacitors.

2. Description of the Related Art

In some specific structures, there is a need for the fabrication of tunable capacitors, the capacitance of which varies as a function of the applied voltage. To manufacture such capacitors, it has been proposed to use barium strontium titanate, (BaSr)TiO3, or BST, as a dielectric.

FIG. 1A shows such a capacitor during an intermediate manufacturing step. On a substrate 1 is formed a metallic layer 3, generally of platinum. On this layer, a BST layer 5 has been deposited, itself covered with a photoresist 7, in which an opening 8 has been formed by photolithography at the position where it is desired to form an opening 9 in the BST layer.

FIG. 1A shows the structure after photolithography 20 of layer 7 and etching of layer 5. FIG. 1B is a top view of the structure at this step. The etching of the BST layer is conventionally performed using an acid etching solution of hydrofluoric acid and nitric acid. It can be noticed that the etching of the BST layer 5 suffers from several drawbacks. Firstly, the etching extends relatively far laterally under the photoresist layer 7. The lateral etching may extend under layer 7 by up to five times the thickness of the BST layer. Secondly, this lateral etching is irregular, as shown in FIG. 1B, and some cracks 10 extend from the edge of the opening 9 into the BST layer. These cracks are responsible for infiltrations and may damage the dielectric properties of the BST layer where they appear. As a result, a capacitor manufactured in this way does not present desired characteristics.

### BRIEF SUMMARY

One embodiment of the present disclosure is solves at least one of the drawbacks of the conventional methods of etching a BST layer.

A more specific embodiment of the present disclosure provides an etching solution providing a regular etching of a BST layer.

One embodiment of the present disclosure provides a method for etching a PVD deposited barium strontium titanate (BST) layer, wherein a non-ionic surfactant at a concentration between 0.1 and 1 percent is added to an acid etching solution.

According to an embodiment, the concentration of the surfactant is between 0.2 and 0.4 percent. According to an embodiment, the etching solution is an aqueous solution of hydrofluoric acid and nitric acid.

According to an embodiment, the surfactant is alkylphenoxy-polyglycidol. According to an embodiment, the BST layer lies on a platinum layer.

An embodiment of the present disclosure provides a tunable capacitor with a BST dielectric obtained by the above method.

### BRIEF DESCRIPTION OF THE SEVERAL VIEWS OF THE DRAWINGS

The foregoing and other features, aspects and advantages of the disclosure will become apparent from the following detailed description of embodiments, given by way of illustration and not limitation with reference to the accompanying drawings, wherein:

FIG. 1A, previously described, illustrates schematically an etched BST layer;

FIG. 1B, previously described, is a top view of the etched BST layer of FIG. 1A;

FIG. 2A illustrates schematically an etched BST layer;

FIG. 2B is a top view of the etched BST layer of FIG. 2A.

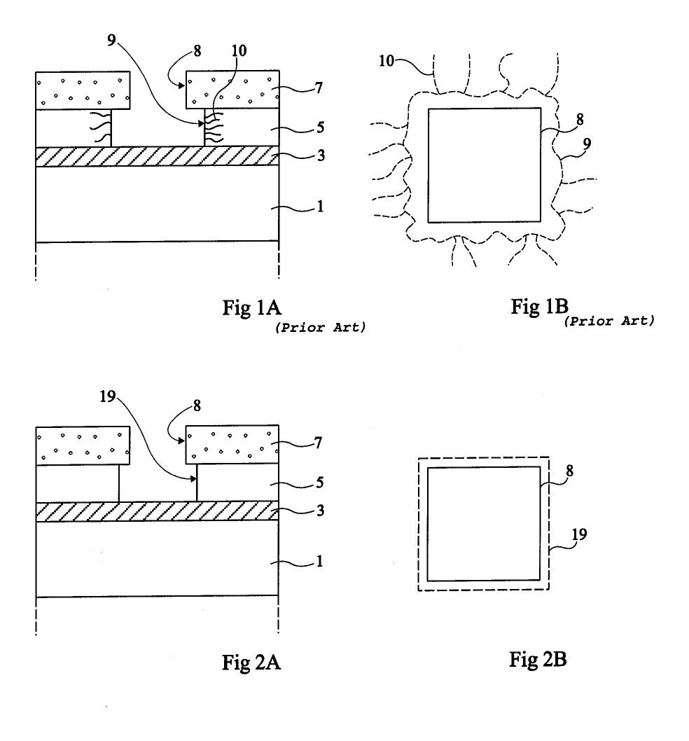

For clarity, the same elements have been designated with the same reference numerals in the different drawings, and furthermore, as is usual in the representation of semiconductor components, the various drawings are not to scale.

### DETAILED DESCRIPTION

FIG. 2A is a cross section illustrating a tunable capacitor during an intermediate manufacturing step. On a substrate 1, which is for example made of glass, sapphire, alumina, quartz or which is a silicon substrate covered with an isolating layer that constitutes the top layer of a structure, is formed a layer 3 of platinum that will form the lower electrode of the capacitor. On this layer, a sputtered BST film 5 has been formed by physical vapor deposition (PVD), itself covered with a photoresist layer 7, in which an opening 8 has been formed by photolithography at the position where it is desired to form an opening 19 in the BST layer.

FIG. 2A shows the structure after photolithography of layer 7 and etching of layer 5. FIG. 2B is a top view of the structure at this particular step. The etching of the BST layer has been performed by an acid etching solution that is a mixture of hydrofluoric acid and nitric acid in an aqueous solution, into which a non-ionic surfactant has been added. The surfactant is for example alkyl-phenoxy-polyglycidol, at a concentration between 0.1 and 1 percent, preferably between 0.2 and 0.4 percent by volume. The etching solution is for example obtained from a mixture of 1.6 liters of hydrogen fluoride (HF) solution at a concentration of 1 percent, 0.14 liter of HNO₃ solution at a concentration of 70 percent, and 26.25 liters of water.

The lateral etching of the BST layer is regular, as shown schematically by FIG. 2B, and the amount that this lateral etching of the BST layer extends under the photoresist layer 7 is roughly reduced by a factor 2 compared to the use of the same etching solution without surfactant. Additionally, no cracks 10 appear in the BST layer from the edge 19 of the opening formed in this BST layer.

Moreover, the inventors observed that the addition of a surfactant in the acid etching solution has no influence on the etch rate of the BST layer compared to the use of the same etching solution without surfactant. It is considered that the conservation of the etch rate is related to the conservation of the acidity levels of the etching solution thanks to the non-ionic nature of the surfactant used.

By conserving the BST etch rate as compared to the use of the same etching solution without surfactant, the man skilled in the art is able to re-use the know-how concerning the etching of the BST layer, while taking advantage of the benefits related to the method described herein.

The improvement in the lateral etching (thinner and more regular) is attributed to the fact that the surfactant forms aggregates (for example micelles), that obstruct the edge of the etching area under the photoresist layer.

For example, the dimensions of the opening in the photoresist layer may be chosen such that the opening in the BST layer is between several micrometers and several hundred micrometers across.

The disclosure is subject to various modifications, in particular as regards the acids usable for the etching solution. Various surfactants can also be used. The metallic layer 3 that supports the BST layer and will form the lower electrode of the capacitor can be formed of a metal other than platinum. However, it will be noted that the disclosure specifically applies to BST layers deposited by PVD, and not to BST layers resulting from a solgel coating. Also, one skilled in the art will recognize that a top electrode (not shown) will be formed on the BST layer either before or after the etching of the BST layer.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
depositing a barium strontium titanate (BST) layer; and
etching the BST layer using an acid etching solution that includes a non-ionic surfactant at a concentration between 0.1 and 1 percent.

2. The method of claim 1, wherein the concentration of the surfactant is between 0.2 and 0.4 percent.

3. The method of claim 1, wherein the etching solution includes an aqueous solution of hydrofluoric acid and nitric acid.

4. The method of claim 1, wherein the surfactant is alkyl-phenoxy-polyglycidol.

5. The method of claim 1, wherein depositing the BST layer includes depositing the BST layer on a platinum layer.

6. The method of claim 1, wherein the depositing includes depositing the BST layer using physical vapor deposition.

7. The method claim 1, further comprising:
depositing a resist layer on the BST layer; and
exposing a portion of the BST layer by forming an opening through the resist layer, wherein the etching includes etching the exposed portion of the BST layer through the opening.

8. A tunable capacitor, comprising:
a conductive electrode; and
a crack-free barium strontium titanate (BST) dielectric layer positioned on the electrode.

9. The tunable capacitor of claim 8, wherein the BST dielectric layer includes a recess etched using an acid etching solution that includes a non-ionic surfactant at a concentration between 0.1 and 1 percent.

10. A composition, comprising an acid etching solution that includes a non-ionic surfactant at a concentration between 0.1 and 1 percent.

11. The composition of claim 10, wherein the concentration of the surfactant is between 0.2 and 0.4 percent.

12. The composition of claim 10, wherein the etching solution includes an aqueous solution of hydrofluoric acid and nitric acid.

13. The composition of claim 10, wherein the surfactant is alkyl-phenoxy-polyglycidol.
